(19) United States
(12) Patent Application Publication
(10) Pub. No.: US 2026/0264167 A1
(43) Pub. Date: Sep. 10, 2026

(54) FRICTION STIR WELDING TOOL

(71) Applicant: Gühring KG, Albstadt (DE)

(72) Inventor: Matthias HELBIG, Messstetten (DE)

(73) Assignee: Gühring KG, Albstadt (DE)

(21) Appl. No.: 19/557,733

(22) Filed: Mar. 5, 2026

(30) Foreign Application Priority Data
Mar. 7, 2025 (EP) 25162291.6

(51) Int. Cl. B23K 20/12

(52) U.S. Cl. CPC B23K 20/1255

(57) ABSTRACT

A friction stir welding tool (1), which has a specified direction of rotation and which has a base body (2) extending along an axis of rotation (3) and a conically tapered weld pin (10), which axially protrudes from a shoulder (4) on the base body (2) and the jacket surface of which is profiled by means of alternating conical surface sections (16) and flattened portions (14) and by means of a helical groove (20), which is coiled in the opposite direction to the direction of rotation from a weld pin tip (12) in the direction of the shoulder (4). The helical groove (20) runs out in a conical surface section (16) of the jacket surface of the wild pin (10).

The present disclosure relates to a friction stir welding tool, which has a specified direction of rotation and which has a base body extending along an axis of rotation and a conically tapered weld pin axially protruding from a shoulder on the base body.

The friction stir welding (FSW) is an established joining method, which operates below the melting point of the workpieces, which are to be welded, and which is used in particular for welding high-strength aluminum alloys. Even materials, which are difficult to weld or which are dissimilar, such as aluminum with magnesium, copper or steel, can additionally be welded together by means of the friction stir welding.

To create a weld seam between two workpieces, which is formed by means of friction stir welding, a rotating friction stir welding tool with a shoulder and a weld pin (also referred to as pin), which protrudes from the shoulder, is dipped into a joint of the workpieces, which are to be connected, and is moved along the joint. Heat, which is generated by means of friction between the friction stir welding tool, in particular the shoulder as well as the weld pin and the workpieces, plasticizes the material of the workpieces around the weld pin, so that it is circulated and is connected under the tool movement.

Different friction stir welding tools are known from the prior art, which are optimized with respect to their geometry and material properties for different applications. It is in particular known to provide the tool shoulder and/or the weld pin with a, for example, groove-shaped profiling. The shoulder profile significantly influences the frictional heat generation during the friction stir welding. A groove formed on the shoulder can limit or prevent a lateral squeeze-out of material and can provide a larger heat input due to the surface, which is larger compared to a flat shoulder. To improve the material flow and reduce the flow resistance, a groove-shaped profiling, e.g., a helical groove, can be formed on the jacket surface of the wild pin.

In FIGS. 7a and 7b, the publication EP 3 122 510 B1 thus discloses a weld pin of a friction stir welding tool, the jacket surface of which is formed by alternating conical surface sections and flattened portions. The weld pin has a helical groove, which extends from a weld pin tip in the direction of a shoulder of the friction stir welding tool. As follows in particular from FIG. 7b, the helical groove runs out in the region of a flattened portion.

There is generally a need for improving the quality of the weld seam during the friction stir welding. In particular, compacting errors and tunnel formations are to be avoided, which can reduce the mechanical strength of the weld seam and which can potentially be responsible for crack formations or premature failure under stress. Compacting errors and tunnel formations can be created due to insufficient material connection or incomplete mixing of the plasticized material.

Based on the friction stir welding tool known from the EP 3 122 510 B1, the disclosure is based on the object of creating a friction stir welding tool, which avoids compacting errors and tunnel formations as best as possible and which can create a durable weld seam with high quality.

This object is solved by means of a friction stir welding tool as disclosed here. The invention also relates to advantageous designs as described herein.

A friction stir welding tool can have a specified direction of rotation and a base body extending along an axis of rotation and a conically tapered weld pin, which axially protrudes from a shoulder on the base body and the jacket surface of which is profiled by means of alternating conical surface sections and flattened portions and by means of a helical groove, which is coiled in the opposite direction to the direction of rotation from a weld pin tip in the direction of the shoulder. The helical groove can run out in a conical surface section of the jacket surface of the weld pin.

When the friction stir welding tool has a direction of rotation to the right, i.e., a counter-clockwise direction of rotation viewed from the weld pin tip in the direction of the shoulder, the helical groove, which coils around the weld pin in the manner of a thread, is coiled to the left or left-handed, i.e., the helical groove coils counter-clockwise around the weld pin from the weld pin tip in the direction of the shoulder. The coiling of the helical groove, which is in the opposite direction to the direction of rotation of the friction stir welding tool, has the effect that the plasticized material is conveyed or displaced, respectively, from the shoulder in the direction of the weld pin tip. When the friction stir welding tool has a direction of rotation to the left, i.e., clockwise direction of rotation viewed from the weld pin tip in the direction of the shoulder, the helical groove is coiled to the right or right-handed, i.e., the helical groove coils clockwise around the weld pin from the weld pin tip in the direction of the shoulder, in order to generate a material movement from the shoulder in the direction of the weld pin tip. The helical groove thereby preferably extends as closely as possible to the shoulder in order to be able to receive and displace the material plasticized by the shoulder and, as a whole, in order to create a material movement in the direction of the wild pin tip. The term weld pin tip is also understood to be a flattened tip.

The flattened portions can extend from the shoulder to the weld pin tip and reduce the torque, which is necessary for a rotation of the wild pin tip in the workpiece material.

The run-out of the helical groove in a conical surface section of the jacket surface of the weld pin can prevent or reduce, respectively, that plasticized material runs over the conical surface section, in which the helical groove runs out, in the direction of the flattened portion, which leads in the direction of rotation of the friction stir welding tool, and piles up in this region or is displaced outwards away from the weld pin along the shoulder and thus away from a zone, in which the plasticized material is to be mixed, which, as a whole, can lead to a reduced material movement and mixing and lastly to compacting errors and/or tunnel formations in the weld seam. Instead, the run-out of the helical groove in a conical surface section promotes a displacement or conveyance, respectively, of the plasticized material along the helical groove and along the weld pin from the shoulder in the direction of the weld pin tip and thus towards a mixing zone, whereby, as a whole, a constant material conveyance and good mixing of the plasticized material can be ensured. Lastly, weld seams can be formed by means of the friction stir welding tool during the friction stir welding, which weld seams avoid compacting errors and tunnel formations.

In a further embodiment, the run-out of the helical groove adjoins a flattened portion nearest to the conical surface section.

When the run-out of the helical groove adjoins a flattened portion nearest to the conical surface section, the helical groove extends essentially over the entire width of the conical surface sections. Tests have shown that a design of this type ensures a particularly good material entrainment by the helical groove in the direction of the welding pin tip. The plasticized material can thereby be detected and displaced in particular over the groove flanks, which extend essentially over the entire width of the conical surface section. As a whole, a very good material mixing results, whereby compacting errors and tunnel formations in the weld seam are avoided.

The groove profile of the helical groove, which is defined by a specified width and depth, can be fully developed in the conical surface section to the run-out, in which the width and depth reduce.

In other words, the entire run-out of the helical groove, in which the width and depth of the helical groove reduce, can be formed in the conical surface section.

By means of this design of the helical groove, in particular of the run-out of the helical groove, plasticized material can be detected particularly efficiently by the run-out of the helical groove in order to be displaced along the helical groove and in order to be conveyed in the direction of the weld pin tip. Lastly, a very good material mixing results, whereby compacting errors and tunnel formations in the weld seam are avoided.

In a further embodiment, the angle of rotation of the helical groove from the weld pin tip to the run-out of the helical groove is greater than or equal to 360°, preferably lies in a range of greater than or equal to 360° to less than or equal to 720°.

According to this design, the helical groove coils between once and twice around the weld pin. In connection with a weld pin of a common size, which can have an axial length of between 2.5 mm and 3 mm, preferably 2.75 mm, measured from the shoulder to the weld pin tip, the helical groove profile, i.e., the groove width, the groove depth as well as a pitch of the coiling can advantageously be selected so that the helical groove extends from the weld pin tip as closely as possible to the shoulder on the one hand and the helical coil forms a large portion of the jacket surface of the weld pin on the other hand. According to such a configuration, the plasticized material can be displaced from the shoulder to the weld pin tip with relatively few rotations around the weld pin and can be mixed efficiently. For example, the groove depth can be between 0.5 mm and 0.7 mm, preferably 0.6 mm, and the pitch of the coiling can be between 1 mm and 1.5 mm, preferably 1.25 mm. A flank angle of the helical coil can be between 55° and 65°, preferably 60°.

The shoulder can be profiled by means of a spiral groove, which extends from a radially outer region of the shoulder in the direction of the weld pin and which runs out adjoining a flattened portion.

The spiral groove, which can also be referred to as scroll, can, on the one hand, limit or prevent a lateral press-out of material and can provide a larger heat input due to the larger surface. The spiral groove can furthermore displace actively plasticized material from a radially outer region of the shoulder in the direction of the weld pin and can lastly promote the material mixing. Tests have shown that the material mixing is particularly successful when the spiral groove runs out so as to adjoin a flattened portion of the wild pin. It can thus be avoided that regions are created on the wild pin base, in which a mixing of plasticized material does not take place or takes place only slightly. Lastly, compacting errors and tunnel formations in the weld seam can be avoided.

Just like the coiling of the helical groove, a spiralization, i.e., a direction of rotation of the spiral groove, can be adapted to the direction of rotation of the friction stir welding tool so that the spiral groove displaces or conveys, respectively, plasticized material from a radially outer region of the shoulder in the direction of the wild pin. When the friction stir welding tool has a direction of rotation to the right, i.e., a counter-clockwise direction of rotation viewed from the weld pin tip in the direction of the shoulder, the spiral groove is spiralized so that it runs clockwise from a radially outer region of the shoulder in the direction of the wild pin. When the friction stir welding tool has a direction of rotation to the left, i.e., a clockwise direction of rotation viewed from the weld pin tip in the direction of the shoulder, the spiral groove is spiralized so that it runs counter-clockwise from a radially outer region of the shoulder in the direction of the weld pin.

The run-out of the spiral groove can contact the flattened portion. The plasticized material, which is displaced by the spiral groove, can be conveyed directly to the base of the weld pin in this way. It can thus be avoided particularly well that regions are created on the weld pin base, in which a mixing of plasticized material does not take place or takes place only slightly. Lastly, compacting errors and tunnel formations in the weld seam can be avoided.

In a further embodiment, the spiral groove can enclose the base region of the flattened portion adjoining the shoulder.

This design has the effect that a largest possible region of the shoulder is profiled by means of the spiral groove and the spiral groove can efficiently guide plasticized material to the base of the wild pin, in particular to the base of a flattened portion, whereby the material mixing and lastly the weld seam quality can be improved. The spiral groove enclosing the flattened portion can advantageously extend into the region of the conical surface section nearest to the flattened portion, wherein the conical surface section is that surface section of the conical surface sections, in which the helical groove of the weld pin runs out. The plasticized material can thus be displaced or conveyed, respectively, particularly efficiently through the spiral groove and the helical groove and can lastly be mixed.

The angle of rotation of the spiral groove from the radially outer region to the run-out of the spiral groove can be greater than or equal to 360°, preferably lie in a range of greater than or equal to 360° to less than or equal to 1080°.

The spiral groove profile, i.e., the groove width as well as a pitch of the spiral groove, can advantageously be selected so that the spiral groove forms a largest possible portion of the shoulder surface. A lateral press-out of material can thus be limited or prevented, a larger heat input generated by means of friction can simultaneously be provided due to the surface, which is larger compared to a shoulder surface without spiral groove. For a friction stir welding tool, which has a shoulder diameter of 14 mm, the spiral groove can have a semicircular groove cross section with a radius of 0.6 mm.

In a further embodiment, the shoulder can lie in a plane transversely to the axis of rotation.

In particular when the shoulder is profiled, for example with a spiral groove, it can be prevented that material is laterally pressed out from the shoulder during the friction stir welding and that the material mixing suffers. The shoulder can lie in a plane transversely to the axis of rotation and can be produced easily. An additional machining of the shoulder, for example in order to form a concavity, which can avoid or prevent the lateral press-out of material, is unnecessary.

The shoulder can have a bezel on the outer circumferential side.

In addition to the weld pin, the shoulder of the friction stir welding tool is that part of the tool, which is stressed the most and which is in direct contact with the workpieces during the welding process in order to generate frictional heat and in order to plasticize the workpiece material. The bezel formed on the outer circumferential side of the shoulder increases the tool stability in this strongly stressed region and contributes to a long tool service life.

The weld pin tip can be flat.

Compared to a weld pin tip, which is tapered in cone-shaped manner, for example, a flat weld pin tip offers the advantage of a good control of the weld seam geometry due to a reduced penetration depth in particular when welding thin component parts. A flat weld pin tip predominantly moves the material laterally and not downwards. This minimizes the risk of material accumulations and Of non-uniform weld seam profiles.

In a further embodiment, the weld pin has three conical surface sections with flattened portions lying therebetween.

The three flattened portions can in each case extend from the shoulder to the weld pin tip and reduce the torque, which is necessary for a rotation of the wild pin tip in the workpiece material. The three flattened portions can be arranged so as to be distributed evenly at an angular distance of 120° each around the axis of rotation of the tool. The edges of the flattened portions act as additional frictional zones, which leads to a locally increased heat generation. This can be advantageous in particular in the case of high-strength materials in order to ensure a good plasticization of the workpiece material.

In a further embodiment, the helical groove can be formed to be continuous from the weld pin tip to its run-out in the conical surface section.

In other words, the helical groove can be formed in the conical surface sections as well as in the flattened portions. The continuous helical groove, in particular the groove flanks thereof, ensures a stable and constant material flow from the shoulder in the direction of the weld pin tip and simultaneously for a good mixing of the plasticized material.

Further details, features and advantages result from the following description of an embodiment and on the basis of the drawings, in which:

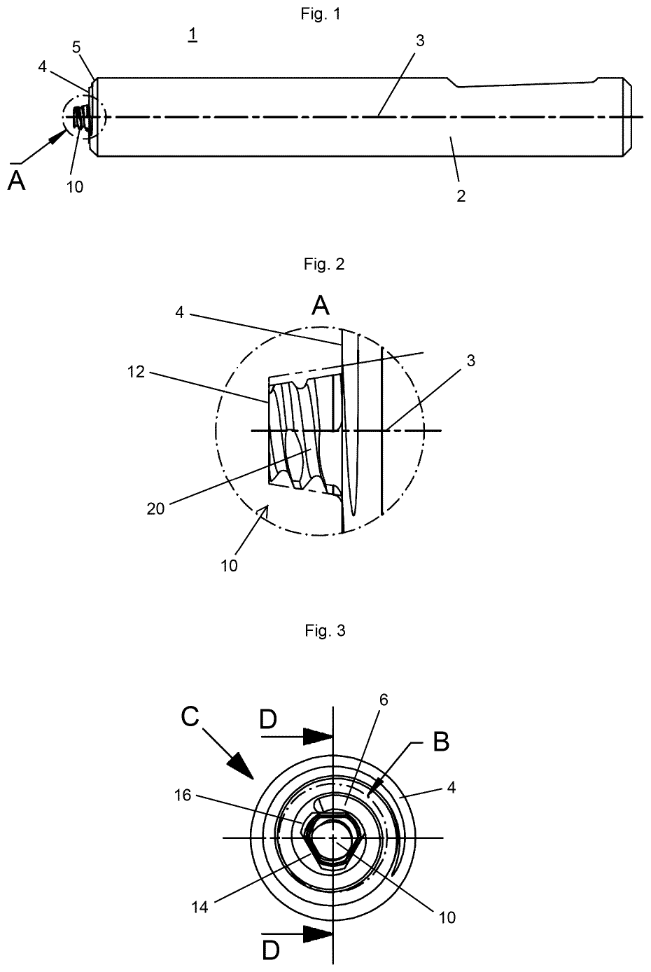

FIG. 1 shows a side view of a friction stir welding tool of one embodiment;

FIG. 2 shows a detail view of a detail A from FIG. 1;

FIG. 3 shows a front view of the friction stir welding tool from FIG. 1;

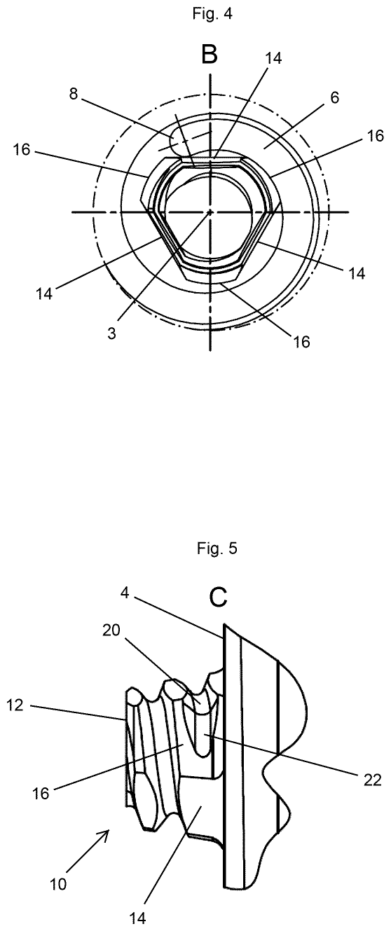

FIG. 4 shows a detail view of a detail B from FIG. 3;

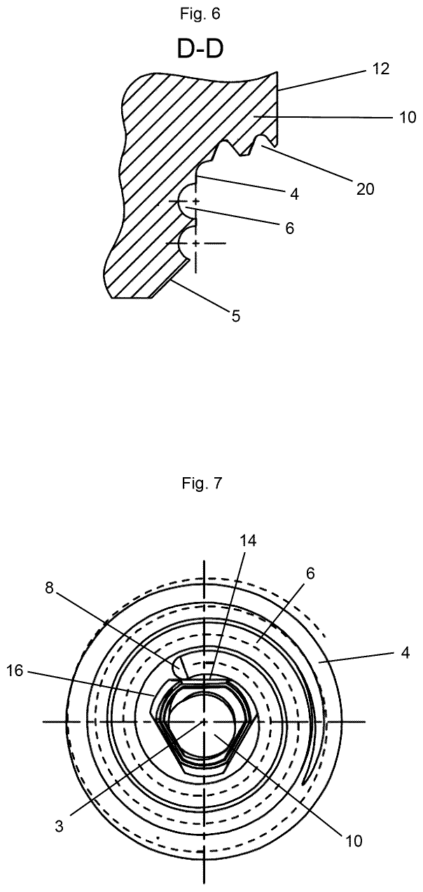

FIG. 5 shows a detail view of a detail C from FIG. 3;

FIG. 6 shows a sectional view along a cutting line D-D from FIG. 3; and

FIG. 7 shows a further front view of the friction stir welding tool from FIG. 1.

FIGS. 1 to 7 show different views of a friction stir welding tool 1 according to one embodiment. The friction stir welding tool 1 has a base body 2, which extends along an axis of rotation 3. On its rear end on the right in FIG. 1, the base body 2 has a clamping section for clamping into a machine tool spindle. On its front end on the left in FIG. 1, the base body 2 forms a shoulder 4, which lies in a plane transversely to the axis of rotation 3, from which a conically tapered weld pin 10 protrudes. An axis of rotation of the wild pin 10 coincides with the axis of rotation 3 of the base body 2. The shoulder 4 has a bezel 5 on the outer circumferential side.

The friction stir welding tool 1 according to the embodiment has a direction of rotation to the left, i.e., the friction stir welding tool 1 has a clockwise direction of rotation viewed from the weld pin 10 in the direction of the shoulder 4 and along the axis of rotation 3.

FIG. 2 is a detail view of a detail A from FIG. 1 and illustrates the weld pin 10 in an enlarged view. The weld pin 10 has a flat weld pin tip 12. As can be seen in FIGS. 3 and 4, a jacket surface of the wild pin 10 is profiled by means of alternating conical surface sections 16 and flattened portions 14. The weld pin 10 in particular has three conical surface sections 16 with flattened portions 14 lying therebetween. The three flattened portions 14 in each case extend from the shoulder 4 to the weld pin tip 12 and reduce the torque, which is necessary for a rotation of the weld pin 10 in the workpiece material. The three flattened portions 14 are arranged so as to be distributed evenly at an angular distance of 120° each around the axis of rotation 3.

A helical groove 20, which is coiled to the right or right-handed, coils clockwise around the weld pin 10 from the weld pin tip 12 in the direction of the shoulder 4. The helical groove 20, which is coiled in the opposite direction to the direction of rotation of the friction stir welding tool 1, generates a movement of plasticized material from the shoulder 4 in the direction of the wild pin tip 12 during the friction stir welding.

As shown in FIG. 5, the helical groove 20 extends as closely as possible to the shoulder 4. The helical groove 20 furthermore runs out in a conical surface section 16. The run-out 22 of the helical groove 20 is that region, within which the depth and width of the helical groove 20 reduces. The run-out 22 of the helical groove 20 in a conical surface section 16 of the jacket surface of the wild pin 10 can prevent or reduce, respectively, that plasticized material runs out over the conical surface section 16, in which the helical groove 20 runs out, in the direction of the flattened portion, which leads in the direction of rotation of the friction stir welding tool 1 and which is identified with reference numeral 14 in FIG. 5, and piles up in this region or is displaced outwards away from the weld pin 10 along the shoulder 4 and thus away from a zone, in which the plasticized material is to be mixed. Instead, the run-out 22 of the helical groove 20 in a conical surface section 16 promotes a displacement or conveyance, respectively, of the plasticized material along the helical groove 20 and along the weld pin 10 from the shoulder 4 in the direction of the weld pin tip 12 and thus towards a mixing zone, whereby, as a whole, a constant material conveyance and good mixing of the plasticized material can be ensured.

As can furthermore be seen in FIG. 5, the run-out 22 of the helical groove 20 adjoins a flattened portion, which is nearest to the conical surface section 16 and which is identified with reference numeral 14 in FIG. 5. The helical groove 20 thus extends over almost the entire width of the conical surface section 16. In the conical surface section 16, in which the run-out 22 lies, the groove profile of the helical groove 20, which is defined by a specified width and depth, is fully developed to the run-out 22, in which the width and depth reduce. In other words, the entire run-out 22 of the helical groove is formed in the conical surface section 16.

The helical groove 20 is formed to be continuous from the weld pin tip 12 to its run-out 22 in the conical surface section 16. This means that the helical groove 20 is formed in the three conical surface sections 16 as well as in the three flattened portions 14. The continuous helical groove 20, in particular the groove flanks thereof, ensures a stable and constant material flow from the shoulder 4 in the direction of the wild pin tip 12 and simultaneously for a good mixing of the plasticized material.

As shown in FIGS. 3, 4 and 7, the shoulder 4 is profiled by means of a spiral groove 6, which can also be referred to as scroll. The spiral groove 6 extends from a radially outer region of the shoulder 4 in the direction of the weld pin 10 and runs out adjoining a flattened portion 14. On the one hand, the spiral groove 6 can limit or prevent a lateral press-out of material from the shoulder 4 and can provide a larger heat input by means of friction due to the surface, which is larger compared to a flat shoulder. The spiral groove 6 can furthermore displace actively plasticized material from a radially outer region of the shoulder 4 in the direction of the wild pin 10 and can lastly promote the material mixing.

In the shown embodiment, the run-out 8 of the spiral groove 6 contacts the flattened portion 14. The plasticized material, which is displaced by the spiral groove 6, can be conveyed directly to the base of the weld pin 10 in this way. It can thus be avoided particularly well that regions are created on the weld pin base, in which a mixing of plasticized material does not take place or takes place only slightly. The spiral groove 6 in particular encloses the base region of the flattened portion 14 adjoining the shoulder 4. This design makes it possible that the largest possible region of the shoulder 4 is profiled by means of the spiral groove and the spiral groove 6 can efficiently guide plasticized material to the base of the weld pin 10, in particular to the base of a flattened portion 14, whereby the material mixing and lastly the weld seam quality can be improved.

### LIST OF REFERENCE NUMERALS

1 friction stir welding tool
2 base body
3 axis of rotation
4 shoulder
5 bezel
6 spiral groove
8 run-out
10 weld pin
12 weld pin tip
14 flattened portion
16 conical surface section
20 helical groove
22 run-out

1. A friction stir welding tool, which has a specified direction of rotation and which has a base body extending along an axis of rotation and a conically tapered weld pin, which axially protrudes from a shoulder on the base body and a jacket surface of which is profiled by means of alternating conical surface sections and flattened portions and by means of a helical groove, which is coiled in an opposite direction to the direction of rotation from a weld pin tip in a direction of the shoulder, wherein the helical groove runs out in a conical surface section of the jacket surface of the weld pin.

2. The friction stir welding tool according to claim 1, wherein the run-out of the helical groove adjoins a flattened portion nearest to the conical surface section.

3. The friction stir welding tool according to claim 1, wherein a groove profile of the helical groove, which is defined by a specified width and depth, is fully developed in the conical surface section to the run-out, in which the width and depth reduce.

4. The friction stir welding tool according to claim 1, wherein an angle of rotation of the helical groove from the weld pin tip to the run-out of the helical groove is greater than or equal to 360°.

5. The friction stir welding tool according to claim 1, wherein the shoulder is profiled by means of a spiral groove, which extends from a radially outer region of the shoulder in a direction of the weld pin and which runs out adjoining a flattened portion.

6. The friction stir welding tool according to claim 5, wherein the run-out of the spiral groove contacts the flattened portion.

7. The friction stir welding tool according to claim 5, wherein the spiral groove encloses a base region of the flattened portion adjoining the shoulder.

8. The friction stir welding tool according to claim 5, wherein an angle of rotation of the spiral groove from the radially outer region to the run-out of the spiral groove is greater than or equal to 360°.

9. The friction stir welding tool according to claim 1, wherein the shoulder lies in a plane transversely to the axis of rotation.

10. The friction stir welding tool according to claim 1, wherein the shoulder has a bezel on an outer circumferential side.

11. The friction stir welding tool according to claim 1, wherein the weld pin tip is flat.

12. The friction stir welding tool according to claim 1, wherein the weld pin has three conical surface sections with flattened portions lying therebetween.

13. The friction stir welding tool according to claim 1, wherein the helical groove is formed to be continuous from the weld pin tip to its run-out in the conical surface section.

14. The friction stir welding tool according to claim 1, wherein an angle of rotation of the helical groove from the weld pin tip to the run-out of the helical groove lies in a range of greater than or equal to 360° to less than or equal to 720°.

15. The friction stir welding tool according to claim 5, wherein an angle of rotation of the spiral groove from the radially outer region to the run-out of the spiral groove lies in a range of greater than or equal to 360° to less than or equal to 1080°.
